(19) United States
(12) Patent Application Publication
(10) Pub. No.: US 2005/0005425 A1
(43) Pub. Date: Jan. 13, 2005

(54) Method and apparatus for HDD suspension gimbal-dimple separation (contact) force measurement

(75) Inventors: Visit Thaveeprungsriporn, Bangkok (TH); Szu-Han Hu, Bangkok (TH); Khampon Sitthipongpanich, Bangkok (TH); Tossapon Chettaisong, Pathumthani (TH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: KR Precision Public Company Limited, Ayutthaya (TH)

(21) Appl. No.: 10/848,509

(22) Filed: May 17, 2004

Related U.S. Application Data
(60) Provisional application No. 60/471,856, filed on May 19, 2003.

(51) Int. Cl. G11B 5/187

(52) U.S. Cl. 29/603.03; 360/122; 360/126

(57) ABSTRACT

Apparatus and techniques for measuring dimple-gimbal separation force for a suspension assembly in a computer disk, commonly called a hard disk drive (HDD), for understanding the impact on suspension dynamic performance. More particularly, the present invention provides readily procedures and methods for measuring the contact force exert between a gimbal and dimple of a HDD suspension assembly. Merely by way of example, the present invention is implemented using such procedures and methods to directly probe the gimbal-dimple contact force, yet it would be recognized that the invention has a much broader range of applicability on any mechanical apparatus that is small in dimension and structure stiffness, such as, micro actuators and micro electrical and mechanical system (MEMS) devices.

### CROSS-REFERENCES TO RELATED APPLICATIONS

This application claims priority from U.S. provisional patent application No. 60/471,856, filed May 19, 2003, entitled “Method and Apparatus for HDD Suspension Gimbal-Dimple Separation (Contact) Force Measurement,” (Attorney Docket No. 021612-001900US) which disclosures are incorporated herein by reference.

### BACKGROUND OF THE INVENTION

The present invention relates generally to disk drives. More particularly, the invention provides a method and device for measuring suspension gimbal-dimple separation using a non-destructive technique. Merely by way of example, the invention has been provided to hard disk drives although other applications may exist.

Head suspension assemblies have been commonly used in rigid magnetic disk drives to accurately position the read and write head in close proximity to the spinning storage medium. Such assemblies include a base plate, a load beam and a flexure (gimbal) to which a slider is to be mounted. The slider support the read/write head and possess special aerodynamic shape allowing the head to fly over the air bearing created by the rotating disk. The load beam is generally composed of an actuator mounting section, a spring and a rigid region. The spring region gives the suspension a spring force or preload counteracting the aerodynamic lift force created by the spinning medium during reading/writing. The flexure is mounted at the distal end of the load beam and support the slider allowing this one to have pitch and roll movement in order to follow the irregularities of the disk surface.

A conventional manufacturing method for such suspension is composed of steps including: etching, trace mounting, forming, stabilization, gram adjust, pitch and roll adjust, de-tab, cleaning, packaging, and possibly others. From a thin sheet of stainless steel, a strip of pre-shaped suspensions are formed by chemical etching. Next the trace or circuit, giving electrical connectivity to the head is mounted. Each flat strip is then fed to the gram load adjustment machine. The method forms the spring region (e.g., large bending) giving a large initial gram load. Such forming method is generally realized by stamping, rolling, or coining and results in a non-equilibrium microstructure of the spring region. A phase of stabilization of the spring region is often necessary. Generally, the use of heat treatment is employed to re-distribute the stress in stainless steel. Then the suspension's gram load has is often fine adjusted, which gives the suspension its nominal preload.

The gimbal-dimple contact force often plays an important role to stabilize the dynamic performance during suspension load/unload and data seeking process. The material thickness variation and assembly tolerance could contribute significant differences to the contact force. It is of importance to determine an accurate contact force of a suspension assembly hence to validate the quality of the design and assembly. Measurement techniques must often be used to ensure the accuracy of the gimbal-dimple contact force.

To measure the dimple contact force, the conventional method attaches, pulls, and monitors the limitations of it by a destructive technique. The conventional method by attaching, pulling, and monitoring reaches its limitation as the feature size decreasing dramatically for advanced HDD. Besides, the conventional monitoring method produces significant error on the measurement since it relies on human judgment and the method is destructive. Namely the specimen cannot be reused or subjected to other characteristic tests. Accordingly, numerous limitations exist with the convention methods. These and other limitations are described throughout the present specification and more particularly below.

From the above, it is seen that an improved method for manufacturing disk drive apparatus is desirable.

### BRIEF SUMMARY OF THE INVENTION

This invention generally relates to apparatus and techniques for measuring dimple-gimbal separation force for a suspension assembly in a computer disk, commonly called a hard disk drive (HDD), for understanding the impact on suspension dynamic performance. More particularly, the present invention provides readily procedures and methods for measuring the contact force exert between a gimbal and dimple of a HDD suspension assembly. Merely by way of example, the present invention is implemented using such procedures and methods to directly probe the gimbal-dimple contact force, yet it would be recognized that the invention has a much broader range of applicability on any mechanical apparatus that is small in dimension and structure stiffness, such as, micro actuators and micro electrical and mechanical system (MEMS) devices.

In a specific embodiment, the present invention provides a method for manufacturing a hard disk drive assembly. The method includes providing a suspension comprising a load beam and dimple region from a production line. The suspension is one of a plurality of suspensions manufactured on the production line. The method includes transferring the load beam to a jig assembly coupled to a measurement device and coupling the suspension to the jig assembly to secure the suspension to the jig assembly for test purposes. The method includes positioning a probe coupled to the measurement device over a portion of the suspension in the jig assembly and targeting a portion of the suspension using a probe. The method contacts the probe to a portion of the suspension to capture a test signal associated with a force associated with the suspension and transfers the test signal to the measurement device. Preferably, the force is characterized by at least a first portion and a second portion, which is associated with a separation between the gimbal region and the dimple region. Preferably, the first portion is associated with substantially no separation between the gimbal and dimple regions. The first portion includes interaction forces (such as attractive forces) between the gimbal region and the dimple region according to a specific embodiment. The method derives test information associated with the suspension from the test signal and processes the test information using a computing device associated with the measurement device coupled to the probe to output a result based upon at least predetermined measurement information of the measurement device. The result is outputted. The method removes the suspension from the jig assembly.

In an alternative specific embodiment, the present invention provides a system for manufacturing a hard disk drive assembly. The system includes a code directed to positioning a probe coupled to a measurement device over a portion of a suspension in the jig assembly and a code directed to targeting a portion of the suspension using a probe. The system also includes a code directed to contacting the probe to a portion (e.g., 1 microns) of the suspension to capture a test signal associated with a force associated with the suspension and a code directed to transferring the test signal to the measurement device. A code is directed deriving test information associated with the suspension from the test signal. A code is also directed to processing the test information using a computing device associated with the measurement device coupled to the probe to output a result based upon at least predetermined measurement information of the measurement device. The system includes a code directed to outputting the result based upon at least the processing of the test information. Depending upon the embodiment, there can also be other computer codes to carry out the functionality described herein.

In yet an alternative embodiment, the present invention provides a method for manufacturing a hard disk drive assembly. The method includes providing a suspension from a production line and coupling the suspension to jig assembly. The method includes targeting a portion of the suspension using a probe and deriving test information associated with the suspension. The method processes -the test information using a computing device coupled to the probe and outputs a result based upon at least the processing.

The HDD suspension gimble-dimple structure is consisted of a 175 to 25 μm thick loadbeam with a dimple and a gimbal of 20 to 15 μm in thickness (FIG. 1). As shown, FIG. 1 is merely an illustration and should not unduly limit the scope of the claims herein. One of ordinary skill in the art would recognize many variations, alternatives, and modifications. The gimbal-dimple contact force plays an important role to stabilize the dynamic performance during suspension load/unload and data seeking process. The material thickness variation and assembly tolerance could contribute significant differences to the contact force. It is of importance to determine an accurate contact force of a suspension assembly hence to validate the quality of the design and assembly.

Due to the small figure and thickness of those features, it is extremely difficult to do nondestructive direct contact measurement on a suspension assembly. The conventional method by attaching, pulling, and monitoring reaches its limitation as the feature size decreasing dramatically for advanced HDD. Besides, the conventional monitoring method produces significant error on the measurement since it relies on human judgment and the method is destructive. Namely the specimen cannot be reused or subjected to other characteristic tests.

In an alternative specific embodiment, the invention provides a simple approach to measure contact force on tiny structures, such as micro actuators and MEMS devices. Those devices are widely adopted by advanced engineering products nowadays. The nondestructive empirical characterization procedures in an embodiment of the invention enable the industry to study stiffness characteristic of those micro-assemblies.

Numerous benefits are achieves using the present invention over conventional techniques. For example, the present technique provides an easy to use process that relies upon conventional technology. In some embodiments, the method provides higher device yields as compared to destructive techniques. Additionally, the method provides a process that is compatible with conventional process technology without substantial modifications to conventional equipment and processes. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified cross-section of a gimbal-dimple structure according to an embodiment of the present invention.

FIG. 2 is a simplified schematic diagram of frictional force between gimbal and dimple according to an embodiment of the present invention.

FIG. 3 is a simplified diagram of a diamond probe tip is probing the reaction force from a gimbal surface according to an embodiment of the present invention.

FIG. 4 is a simplified diagram of a probing scheme applied on gimbal according to an embodiment of the present invention.

FIG. 5 is a simplified diagram of a gimbal-dimple separation indicated by the force and stepping history according to an embodiment of the present invention.

FIG. 6 is a simplified diagram of data extrapolation from force-displacement data according to an embodiment of the present invention.

FIG. 7 is a simplified diagram of a 400×microscopic image that shows the separation occurs right at the curve slope change according to an embodiment of the present invention.

FIGS. 8 and 9 are simplified diagrams illustrating a separation of the gimbal from the dimple during force displacement inspection according to embodiments of the present invention.

FIG. 10 is a top-view illustration of a suspension as referred to a ruler according to an embodiment of the present invention.

### DETAILED DESCRIPTION OF THE INVENTION

The present invention relates generally to disk drives. More particularly, the invention provides a method and device for measuring suspension gimbal-dimple separation using a non-destructive technique. Merely by way of example, the invention has been provided to hard disk drives although other applications may exist.

Hard disk drive (HDD) industry has been seeking for long for a better measurement method, especially, by means of nondestructive methods to determine suspension gimbal-dimple separation force. This separation force plays an important role to depict the system dynamic stability during HDD operation.

Enlighten by frictional force between gimbal-dimple contact surfaces, a Nanoindenter (conventionally used for thin-film hardness measurement or scratch tests) was utilized to accurately perform nondestructive and direct contact measurement of the gimbal-dimple separation force. In a specific embodiment, the nanoindenter allows users to characterize the mechanical properties of the gimbal dimple surfaces. The size and shape of the indenter tip is selected based on the material and properties of interest. Indentations can be imaged in situ using the tip of the indenter as a probe in contact mode. Here, the term separation force is defined by a space or gap between the gimbal and dimple according to a specific embodiment, although other definitions can also be used. As merely an example, the Nanoindenter is manufactured by CSIRO in Australia. Preferably, the nanoindenter includes a computing device, which is used to carrying out the functionality described here. The computing device includes memory. The memory or memories include computer codes in the form of software, which can be used for programming purposes. The contact force sensed by the indenter probe is, in fact, equal and opposite to the separation force. It is evident, the empirical data from the indenter extrapolates the gimbal-dimple separation (contact) force is in a close agreement with a finite element simulation. The frictional mechanism employed by the present invention helps to realize the gimbal-dimple separation without requiring human judgment, like the conventional method does. Accordingly, the present invention provides a substantially non destructive technique for measuring the separation force.

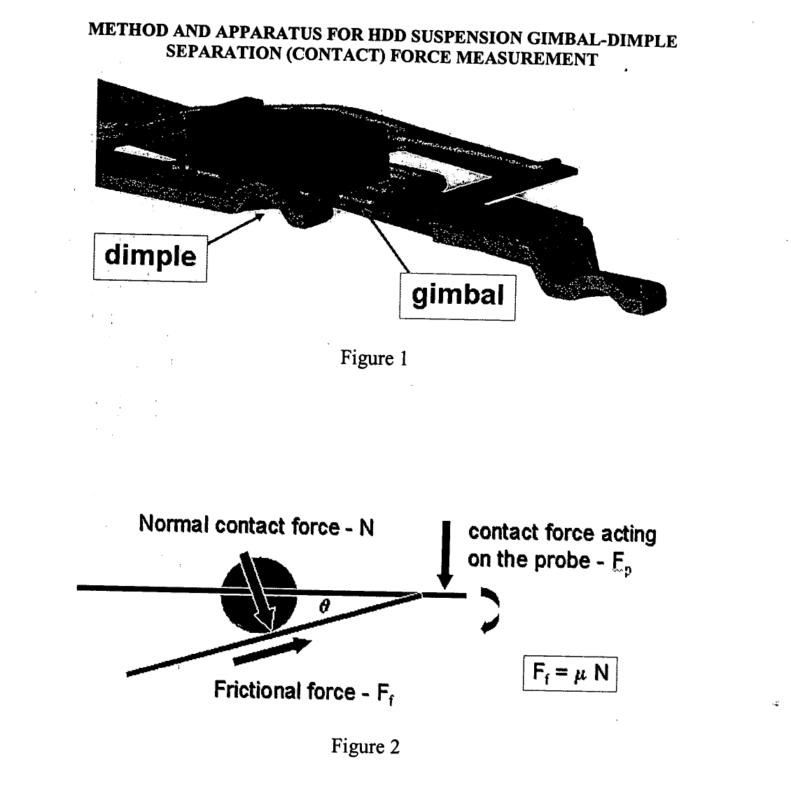

The HDD suspension gimble-dimple structure is consisted of a 175 to 25 μm thick loadbeam with a dimple and a gimbal of 20 to 15 μm in thickness (FIG. 1). FIG. 1 is merely an example, which should not unduly limit the scope of the claims herein. One of ordinary skill in the art would recognize other variations, modifications, and alternatives. The gimbal-dimple contact force plays the role to stabilize the dynamic performance during suspension load/unload and data seeking process. The material thickness variation and assembly tolerance could contribute significant differences to the contact force. It is of importance to determine an accurate contact force of a suspension assembly hence to validate the quality of the design and assembly.

By theory, frictional force occurs on the interface of two contact bodies. Enlighten by this concept (FIG. 2), if a sliding motion could be created between gimbal and dimple and the force that creates this motion could be measured, this force should indicate a slope change once the frictional force vanishes. FIG. 2 is merely an example, which should not unduly limit the scope of the claims herein. One of ordinary skill in the art would recognize other variations, modifications, and alternatives. When a separation occurs, this force should respond to nothing but the overall structure stiffness.

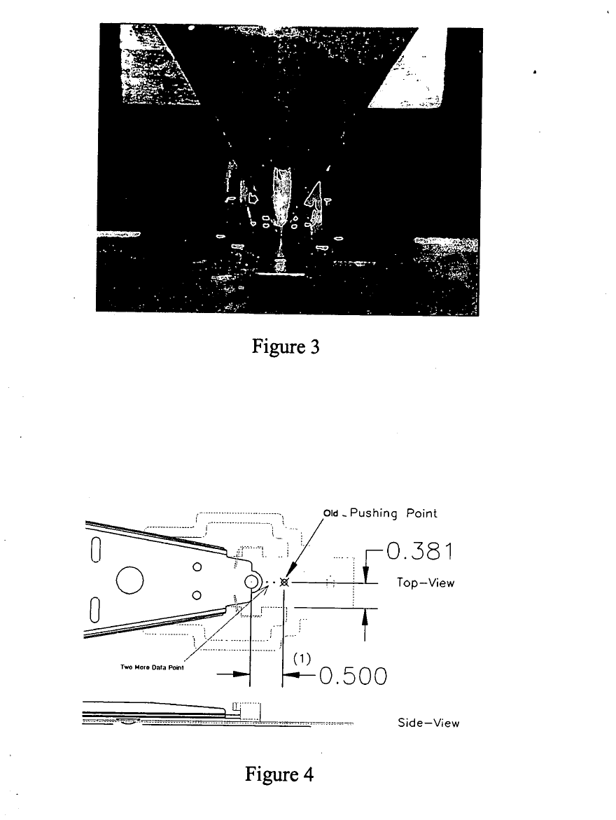

In current invention, an ultra high force resolution indenter is employed to create submicron stepping motion on a vertical probe which is capable to realize a minimum force of 5 μN (FIG. 3). FIG. 3 is merely an example, which should not unduly limit the scope of the claims herein. One of ordinary skill in the art would recognize other variations, modifications, and alternatives.

The stepping and force resolution is able to monitor the slope change within a few microns. The measurement method consists the following steps.

1. Prepare the suspension sample from a regular production.

2. Prepare the parameter setting by the indentation software.

3. Clamp the specimen on a jig with accurate alignment.

4. Targeting the probe to the specimen through a microscope and stepping system.

5. Trigger the instrument, and recode the contact force and displacement history.

6. Repeat the step 4 to 5 on the same specimen at different location along the dimple central line and record the force and displacement history from.

7. Extrapolate the data by extrapolating the force-displacement history from the serial data points.

The steps above provides a general method of using a probe to measure contact force according to an embodiment of the present invention. Depending upon the embodiment, certain steps may be combined or added or even removed. Alternatively, certain steps may even be changed relative to another depending upon the embodiment. Details with regard to these and other features of the invention can be found throughout the present specification and more particularly below.

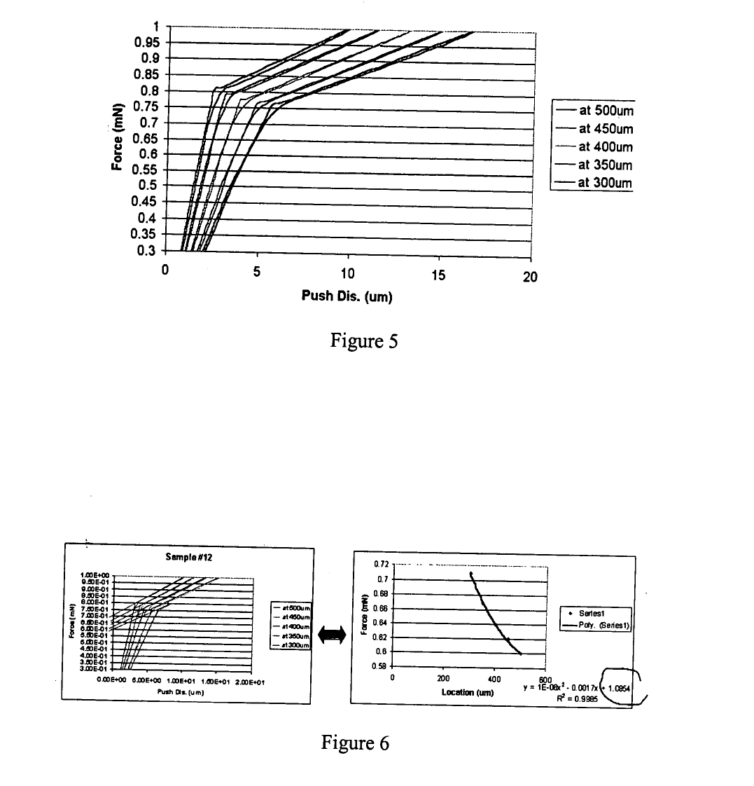

In a preferred embodiment, the procedures includes of 3 to 5 probing locations along the dimple central axis with equal pitch on a gimbal tongue of a suspension (FIG. 4). FIG. 4 is merely an example, which should not unduly limit the scope of the claims herein. One of ordinary skill in the art would recognize other variations, modifications, and alternatives. The accuracy of the measurement depends on the number of data points and how close the last data point approaches to the dimple (FIG. 5). FIG. 5 is merely an example, which should not unduly limit the scope of the claims herein. One of ordinary skill in the art would recognize other variations, modifications, and alternatives.

The data were extrapolated by intersecting the second slope (after separation) with the y-axis which is the contact force sensed by the probe. Here, the slope changes upon separation. As the probing location approaches the dimple (origin of the x-axis), the reaction force detected by the probe should approach to the actual gimbal-dimple contact force (FIG. 6). FIG. 6 is merely an example, which should not unduly limit the scope of the claims herein. One of ordinary skill in the art would recognize other variations, modifications, and alternatives. The second slope from different measurement shows that there is no noticeable slope change between different locations that means the frictional force is no longer acting on the gimbal-dimple interface. By then, the reaction force acting on the probe responds solely to the gimbal and strut stiffness.

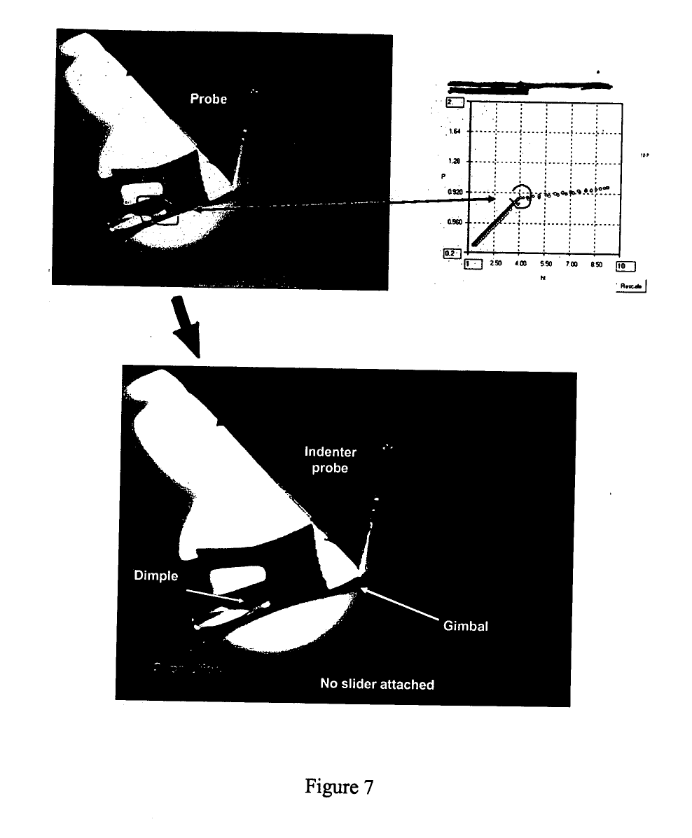

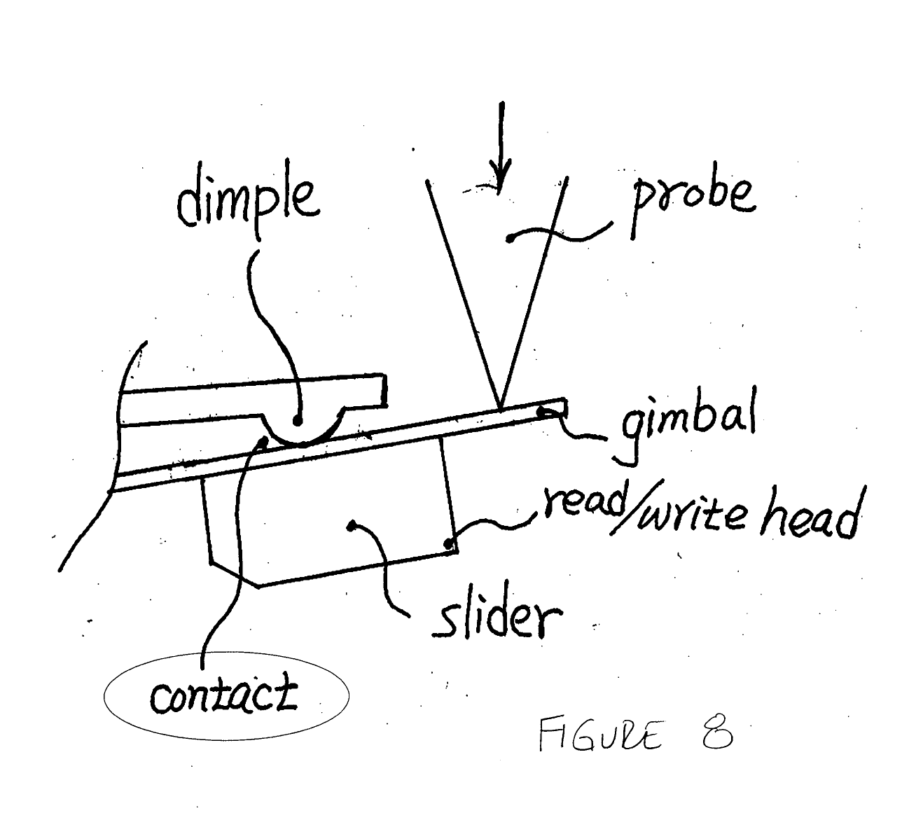

The reading from the intersection was fit to a second order curve fitting. The function indicates that when the x reaches 0 which means dimple center the contact force equals 1.08 mN. The result agrees with a finite element simulation. The measurement is repeatable, nondestructive, and highly accurate. The gimbal-dimple separation during probing was revealed by a microscopic image as well as the indication of slope change (FIG. 7). FIG. 7 is merely an example, which should not unduly limit the scope of the claims herein. One of ordinary skill in the art would recognize other variations, modifications, and alternatives.

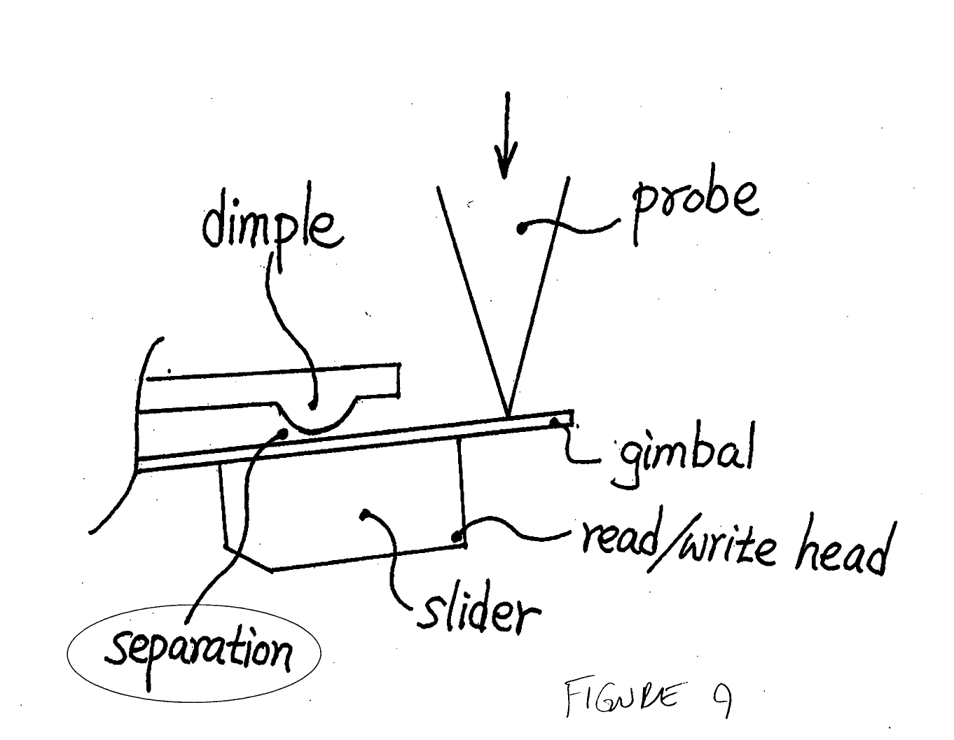

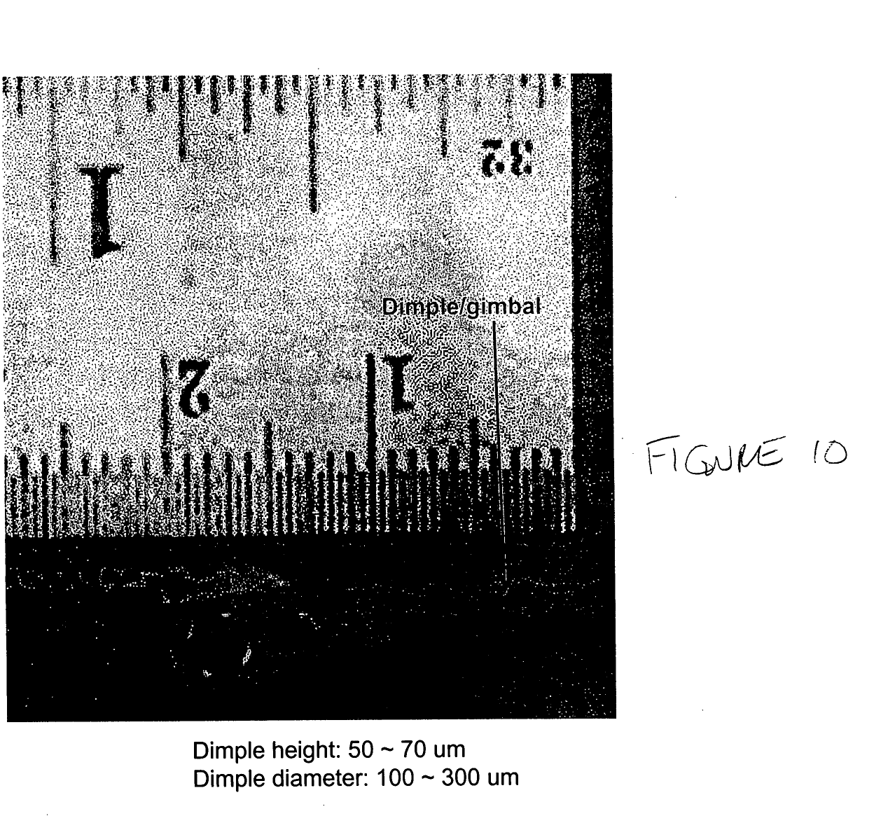

FIGS. 8 and 9 are simplified diagrams 800 900 illustrating a separation of the gimbal from the dimple during force displacement inspection according to embodiments of the present invention. As shown, the side view diagram 800 illustrates a measurement of the gimbal dimple reaction force when the gimbal and dimple are in contact with each other. As shown, the probe is placed in a selected portion of the gimbal portion and is actuated in a downward manner to cause separation of the gimbal from the dimple. The selected portion of the gimbal is often less than 10 microns and is often 1 micron or less. The probe tip also has a size of about 1 micron in preferred embodiments. Details of the separation can be found throughout the present specification and more particularly below.

Referring to FIG. 9, the gimbal and dimple separate, as evidenced by a gap between the gimbal and dimple. Once separation occurs a force characteristic of the gimbal dimple reaction force changes, where we understand that the force is predominately due to the characteristic of the gimbal material and shape. Forces associated with any interaction between the gimbal and dimple are substantially less according to a specific embodiment. Details of these forces have been plotted in the figures illustrated herein. Depending upon the embodiment, there can also be other types of force characteristics.

FIG. 10 is a top-view illustration of a suspension 1000 as referred to a ruler according to an embodiment of the present invention. As shown, the actual size of the suspension is very small as compared to macroscopic objects. As shown, the entire span of the suspension is about 2 centimeters. Dimple height ranges from about 50˜70 um and dimple diameter ranges from about 100˜300 um according to specific embodiments. Of course, there can be other variations, modifications, and alternatives.

It is proved; the gimbal-dimple contact force can be measured by means of nondestructive and direct probing method. In an alternative specific embodiment, the invention is capable to provide simple procedures to measure contact force on tiny structures, such as micro actuators and MEMS devices. The nondestructive empirical characterization procedures in an embodiment of the invention enable the industry to study stiffness characteristic of those micro-assemblies. It would be recognized that the invention could have much broader range of applicability on any other tiny structure.

One of ordinary skill in the art would recognize many other variations, modifications, and alternatives. The above examples are merely illustrations, which should not unduly limit the scope of the claims herein. It is also understood that the examples and embodiments described herein are for illustrative purposes only and that various modifications or changes in light thereof will be suggested to persons skilled in the art and are to be included within the spirit and purview of this application and scope of the appended claims.

1. A method for manufacturing a hard disk drive assembly, the method comprising:
providing a suspension from a production line;
coupling the suspension to jig assembly;
targeting a portion of less than 10 microns of the suspension using a probe;
deriving test information associated with the suspension;
processing the test information using a computing device coupled to the probe;
outputting a result based upon at least the processing.

2. The method of claim 1 wherein the suspension is one of a plurality from the production line.

3. The method of claim 1 wherein the jig assembly holds the suspension in place.

4. The method of claim 1 wherein processing comprising deriving the result based upon at least the test information.

5. The method of claim 1 further comprising touching the probe on the portion of the portion of the suspension to capture first force information characterized by a first relationship and second force information characterized by a second relationship associated with the suspension; wherein the second relationship is associated with a separation state between a gimbal and a dimple, the dimple being associated with a load beam on the suspension.

6. The method of claim 5 wherein the force information is associated with the test information.

7. The method of claim 1 wherein the force information comprises reaction force information.

8. The method of claim 1 further comprising repeating the targeting and deriving for other portions of the suspension.

9. The method of claim 1 wherein the processing comprising associating the test information to predetermined standard information to output the result.

10. The method of claim 1 wherein the test information is associated with pitch, roll, vertical, and lateral characteristics of the suspension.

11. The method of claim 1 wherein the portion of the suspension is a dimple central axis.

12. A method for manufacturing a hard disk drive assembly, the method comprising:
providing a suspension comprising a load beam, a dimple region, and a gimbal region from a production line, the suspension being one of a plurality of suspensions manufactured on the production line, the dimple region being coupled to the gimbal region;
transferring the load beam to a jig assembly coupled to a measurement device;
coupling the suspension to the jig assembly to secure the suspension to the jig assembly for test purposes;
positioning a probe coupled to the measurement device over a portion of the suspension in the jig assembly;
targeting a portion of less than 10 microns of the suspension using a probe;
contacting the probe to a portion of the suspension to capture a test signal associated with a force associated with the suspension, the force being characterized by at least a first portion and a second portion, the second portion being associated with a separation between the gimbal region and the dimple region;
transferring the test signal to the measurement device;
deriving test information associated with the suspension from the test signal;
processing the test information using a computing device associated with the measurement device coupled to the probe to output a result based upon at least predetermined measurement information of the measurement device;
outputting the result based upon at least the processing of the test information; and
removing the suspension from the jig assembly.

13. A system for manufacturing a hard disk drive assembly, the system comprising:
a code directed to positioning a probe coupled to a measurement device over a portion of a suspension in the jig assembly;
a code directed to targeting a portion of the suspension using a probe;
a code directed to contacting the probe to a portion of the suspension to capture a test signal associated with a force associated with the suspension;
a code directed to transferring the test signal to the measurement device;
a code directed deriving test information associated with the suspension from the test signal;
a code directed to processing the test information using a computing device associated with the measurement device coupled to the probe to output a result based upon at least predetermined measurement information of the measurement device; and
a code directed to outputting the result based upon at least the processing of the test information.
